(19) United States
(12) Patent Application Publication
(10) Pub. No.: US 2017/0106692 A1
(43) Pub. Date: Apr. 20, 2017

(54) COVER FOR WRITING INSTRUMENT

(71) Applicant: Anita Imbesi, Wellington, FL (US)

(72) Inventor: Anita Imbesi, Wellington, FL (US)

(21) Appl. No.: 14/882,713

(22) Filed: Oct. 14, 2015

(51) Int. Cl. B43K 31/00; B43K 23/00; B43K 29/00

(52) U.S. Cl. CPC B43K 31/00; B43K 29/00; B43K 23/00

(57) ABSTRACT

A cover for a writing instrument having a body, a protrusion, and a decorative element. The body has a first end, a second end, an inner surface, an outer surface, and a space bounded by the inner surface. The space is operatively arranged to hold a writing instrument. The protrusion has a first end and a second end, where the first end is secured to and extends upwardly from the second end of the body. The decorative element has an extension member extending downwardly, where the extension member is secured to the second end of the protrusion. The body further includes at least one hinge means extending longitudinally about the body and at least one latch.

### FIELD OF THE INVENTION

The invention broadly relates to a cover for a writing instrument, and in particular, to a removable cover having a decorative element secured to an end of the writing instrument.

### BACKGROUND OF THE INVENTION

Writing instruments are well known in the art and have been around for thousands of years. The earliest writing instruments that resembled a pen and paper were developed by the Greeks. They developed a writing instrument, made of metal, bone or ivory, to mark upon wax-coated tablets. The Romans created a reed-pen from the hollow tubular-stems of marsh grasses, such as the bamboo plant. They converted bamboo stems into a primitive form of a fountain pen.

They cut one end into the form of a pen nib or point, filled the stem with an ink, and squeezed the reed to force fluid to the nib.

The writing instrument that proliferated for the longest period in history, over one-thousand years, was the quill pen. The quill pen was introduced around 700 A.D. and was made from a bird feather. Quill pens lasted for only a week before it was necessary to replace them.

There were other disadvantages associated with their use, including a lengthy preparation time. To sharpen the quill, the writer needed a special knife and beneath the writer's desk was a coal stove used to dry the ink as fast as possible. The oldest known fountain pen was designed by Frenchman, M. Bion, in 1702. Peregrin Williamson, a Baltimore shoemaker, received the first U.S. patent for a pen in 1809. John Scheffer received a British patent in 1819 for his half quill, half metal pen that he attempted to mass manufacture. John Jacob Parker patented the first self-filling fountain pen in 1831. However, early fountain pen models were plagued by ink spills and other failures that left them impractical and hard to sell. Therefore, Lewis Waterman invented the first practical fountain pen in 1884. Then in 1938, a Hungarian journalist, Laszlo Biro, invented the first ballpoint pen. The thicker ink would not flow from a regular pen nib so Biro devised a new type of point. He did so by fitting his pen with a tiny ball bearing in its tip. As the pen moved along the paper, the ball rotated picking up ink from the ink cartridge and leaving it on the paper.

Another type of writing instrument, the pencil, was made shortly after the discovery of graphite in about 1564. In 1795, the breakthrough in pencil technology came when French chemist Nicolas Conte developed and patented the process used to make pencils, mixing clay and graphite together and encasing them in wood. In 1770, Edward Naime invented the first eraser, and thus, Europeans began rubbing out pencil marks with small cubes of rubber. The first patent for attaching an eraser to a pencil was issued in 1858 to Hyman Lipman.

Presently, there are a wide variety of writing instruments available, such as ball point pens, retractable pens, gel pens, washable markers, permanent markers, dry erase markers, wood pencils, mechanical pencils, styluses for tablets, etc. As various writing instruments have evolved over time and become an everyday staple, customization has become increasingly important. Out of a need for customization, decorative covers for writing instruments evolved. Currently, there are vast assortment of decorative covers available. One problem with present decorative covers is that the decorative element is bound directly to the writing instrument via an adhesive, such as tape. Another problem with present decorative covers is that the decorative cover and/or decorative element is integral with or fixedly secured to the end of the writing instrument. These instances lead to a subsequent problem, which is that when the writing instrument can no longer be used, i.e., it runs out of ink or lead, the entire writing instrument must be disposed of, including the decorative element.

Thus, there is a long-felt need for a cover for a writing instrument having an interchangeable element that allows for more personalization. Additionally, there is another long-felt need for a cover for a writing instrument where the writing instrument is removably disposed within a space, such that the writing instrument can be interchanged when it is no longer of use.

Furthermore, another problem with present covers for writing instruments are that they are limited to covering the writing instrument without other functions. Thus, there is a long felt need for a cover for a writing instrument that not only provides a decorative element but that also appeals to other senses, such as olfactory senses. Similarly, there is another long felt need for a cover, having a decorative element that can also house a fragrance, such as a perfume or essential oil, as essential oils are thought to provide a variety of health benefits. Moreover, there is a long felt need for a decorative element having fragrances that can be removed and replaced as the fragrance is used.

### BRIEF SUMMARY OF THE INVENTION

The present invention broadly includes a cover for a writing instrument having a body, a protrusion, and a decorative element. The body has a first end, a second end, an inner surface, an outer surface, and a space bounded by the inner surface. The space is operatively arranged to hold a writing instrument. The protrusion has a first end and a second end, where the first end is secured to and extends upwardly from the second end of the body. The decorative element has an extension member extending downwardly therefrom and the extension member is secured to the second end of the protrusion.

In one embodiment, the body further includes at least one opening means, preferably a hinge, extending longitudinally along the body. The hinge divides the body into a first portion and a second portion and the first and second portions pivot about the hinge. The body further includes at least one fastening means, preferably a latch, to secure the body in a closed position. The protrusion further includes an inner surface, an outer surface, and a cavity bounded by the inner surface, and at least a portion of the extension member is disposed within the cavity.

In another embodiment, the decorative element is substantially flower-shaped. In yet another embodiment, the decorative element is substantially spherically shaped. Preferably, the body is made of plastic and substantially tubular-shaped. However, it should be appreciated that any of the elements can be made of any suitable material known in the art and can be of any suitable shape known in the art.

In yet another embodiment, the body further includes a slot and a lever. The lever is disposed within the slot and is operatively arrange to move longitudinally along the slot to accommodate writing instruments of varying heights.

In one embodiment, the present invention broadly includes a cover for a writing instrument, having a body, a decorative element, and at least one opening means. The body has a first end, a second end, an inner surface, an outer surface, and a space bounded by the inner surface. The space is operatively arranged to hold a writing instrument. The decorative element has an extension member extending downwardly therefrom, where at least a portion of the extension member is secured to and extends upwardly from the second end of the body. The least one opening means extends longitudinally along the body and divides the body into a first portion and a second portion. The first and second portions pivot outwardly about the at least one opening means to form an open position. Preferably, the at least one opening means is a hinge.

In another embodiment, the body further includes at least one fastening means to secure the body in a closed position. The body further includes a slot and a lever. The lever is disposed within the slot and is operatively arrange to move longitudinally along the slot to accommodate writing instruments of varying heights.

In yet another embodiment, the decorative element is substantially flower-shaped or substantially spherically shaped. Preferably, the body is made of plastic and substantially tubular-shaped. However, it should be appreciated that any of the elements can be made of any suitable material known in the art and can be of any suitable shape known in the art.

In one embodiment, the decorative element broadly includes a housing, a fragrance disc, and a means for securing the decorative element to an accessory. The housing has a top, a base, and an attachment means. The attachment means secures the top to the base and the top is pivotable about the attachment means. The base has an outer surface, an inner surface, a side and a cavity bounded by the side and the top includes a rim and at least one aperture bounded by the rim. The fragrance disc has an outer surface and an inner surface and is disposed within the cavity bounded by the side. The fragrance disc rests upon the inner surface of the base and the fragrance disc is filled with a scented medium. Preferably, the attachment means that secures the top to the base is a hinge. Preferably, the means for securing the decorative element to an accessory is an extension member extending downwardly therefrom.

In another embodiment, the housing is substantially circular in shape and the top is convex. Preferably, the decorative element is substantially flower-shaped. However, it should be appreciated that any of the elements can be made of any suitable material known in the art and can be of any suitable shape known in the art.

In yet another embodiment, the top further includes at least one barb extending upwardly therefrom, and the decorative element further includes a flower ovary and a plurality of petals. The flower ovary is secured to the at least one barb and the plurality of petals are disposed circumferentially about the base. Preferably, the scented medium is a perfume or an essential oil. However, is should be appreciated that the scented medium can be made of any suitable medium known in the art. Essential oils, such as lavender, have been thought to promote health benefits, such as soothing nervous tension, headaches, anxiety and depression, inducing sleep, relieving pain from soreness in the joints, disinfecting the scalp and skin, enhancing blood circulation, treating respiratory problems, and increasing the mobility of the intestine, as well as a variety of other health benefits.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front perspective view of a first embodiment of a cover of the present invention for a writing instrument, shown in a closed position, having a pen disposed within a space and used to write on a paper;

FIG. 2 is a front perspective view of the cover of FIG. 1, shown with the paper removed;

FIG. 3 is a front elevational view of the cover of FIG. 2, shown with the pen removed;

FIG. 4 is a rear elevational view of the cover of FIG. 3;

FIG. 5 is a bottom plan view of the cover of FIG. 3;

FIG. 6 is a top plan view of the cover of FIG. 3, shown with the decorative element removed;

FIG. 7 is a front perspective view of the cover of FIG. 3, shown in an open position;

FIG. 8 is a front perspective view of a second embodiment of the cover, shown in an open position, having a stylus disposed within the space;

FIG. 9 is a front perspective view of a third embodiment of the cover, shown in an open position, having a pen disposed within the space;

FIG. 10 is a front perspective view of a fourth embodiment of the cover, shown in an open position, having a pencil disposed within the space;

FIG. 11 is an exploded view of an embodiment of a decorative element, shown having a housing in an open position and a fragrance disc disposed within a space;

FIG. 12 is a front elevational view of the decorative element of FIG. 11, shown in an assembled position; and,

FIG. 13 is a top plan view of the housing of the decorative element.

### DETAILED DESCRIPTION OF THE INVENTION

At the outset, it should be appreciated that like drawing numbers on different drawing views identify identical, or functionally similar, structural elements of the invention. It also should be appreciated that figure proportions and angles are not always to scale in order to clearly portray the attributes of the present invention.

While the present invention is described with respect to what is presently considered to be the preferred aspects, it is to be understood that the invention as claimed is not limited to the disclosed aspects. The present invention is intended to cover various modifications and equivalent arrangements included within the spirit and scope of the appended claims.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

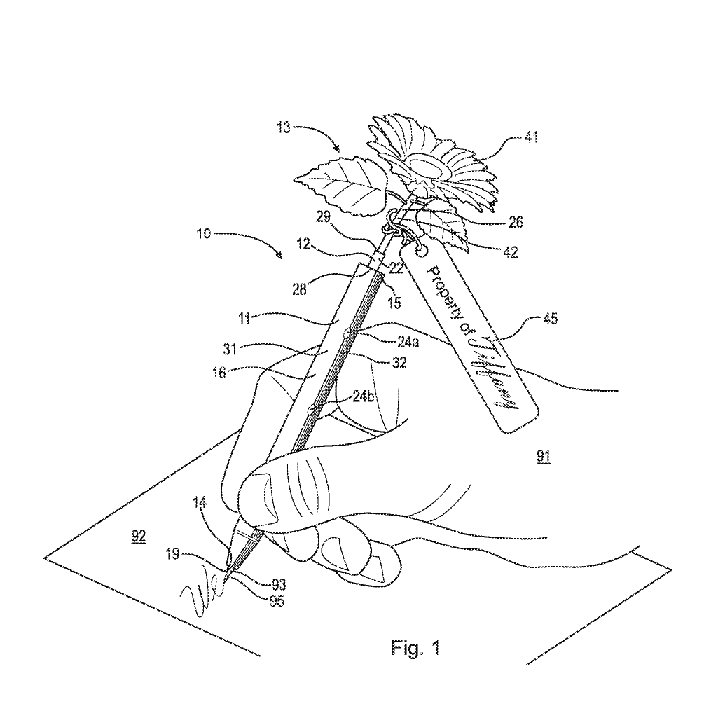

Adverting now to the figures, FIG. 1 is a first embodiment of cover 10 of the present invention for a writing instrument. Cover 10 broadly includes body 11, protrusion 12, and decorative element 13. As shown in FIG. 1, body 11 in a closed position, having pen 93 disposed within space 20. Body 11 is held by hand 91 and being used to write on paper 92. Hand 91 grasps outer surface 16 of body 11. Preferably, cover 10 includes tag 45 secured to body 11 via rope 46.

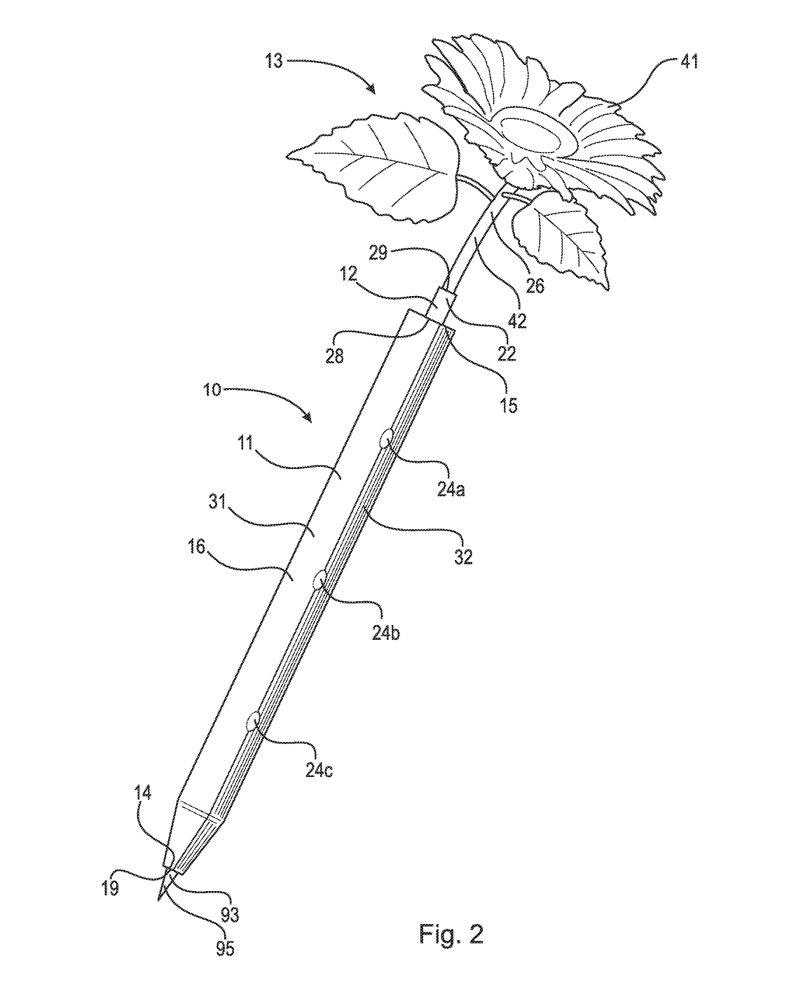

FIG. 2 is a front perspective view of cover 10, shown with paper 92 removed.

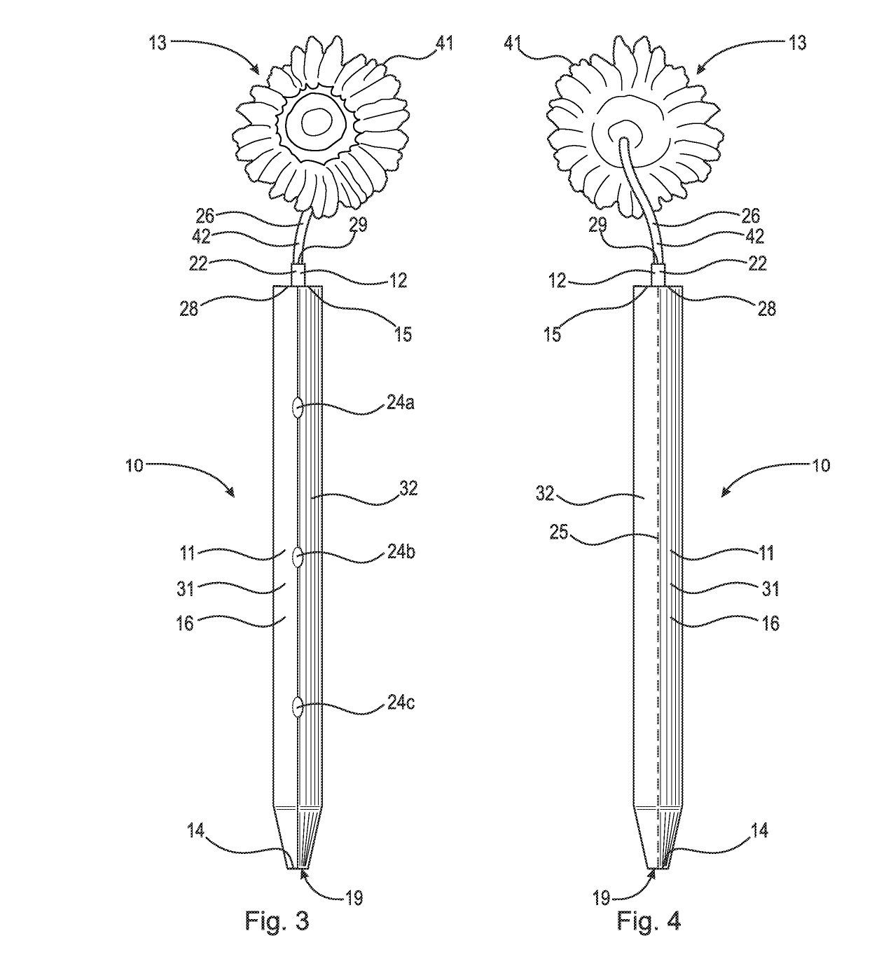

FIG. 3 is a front elevational view of the cover 10, shown with pen 93 removed and FIG. 4 is a corresponding rear elevational view of cover 10.

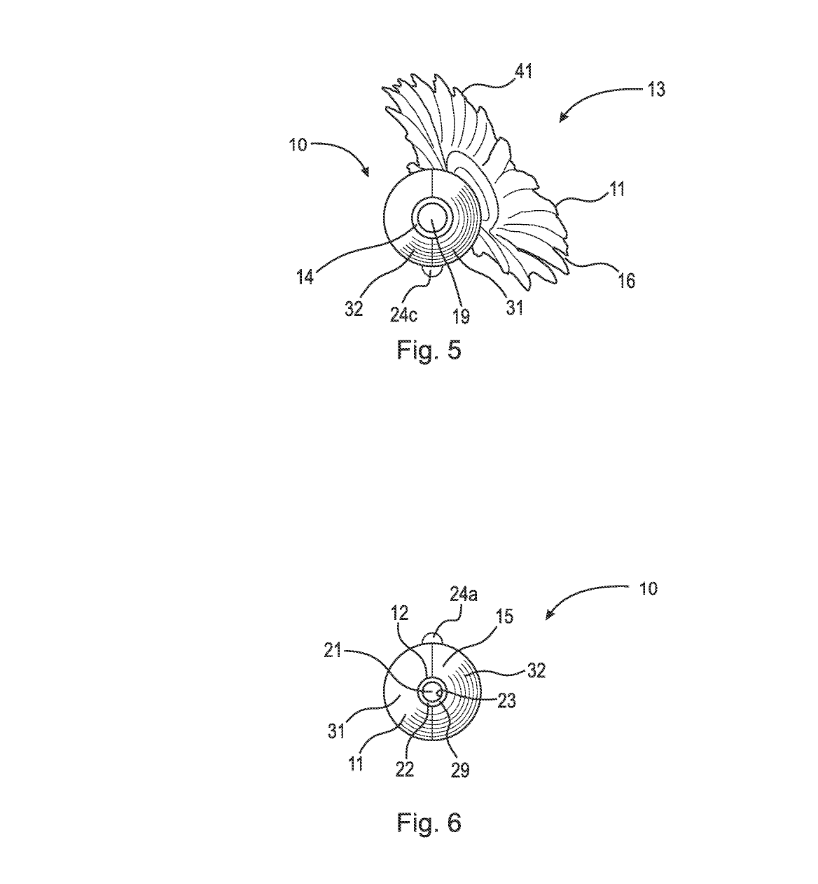

FIG. 5 is a bottom plan view of cover 10 and FIG. 6 is the corresponding top plan view of cover 10, shown with the decorative element removed.

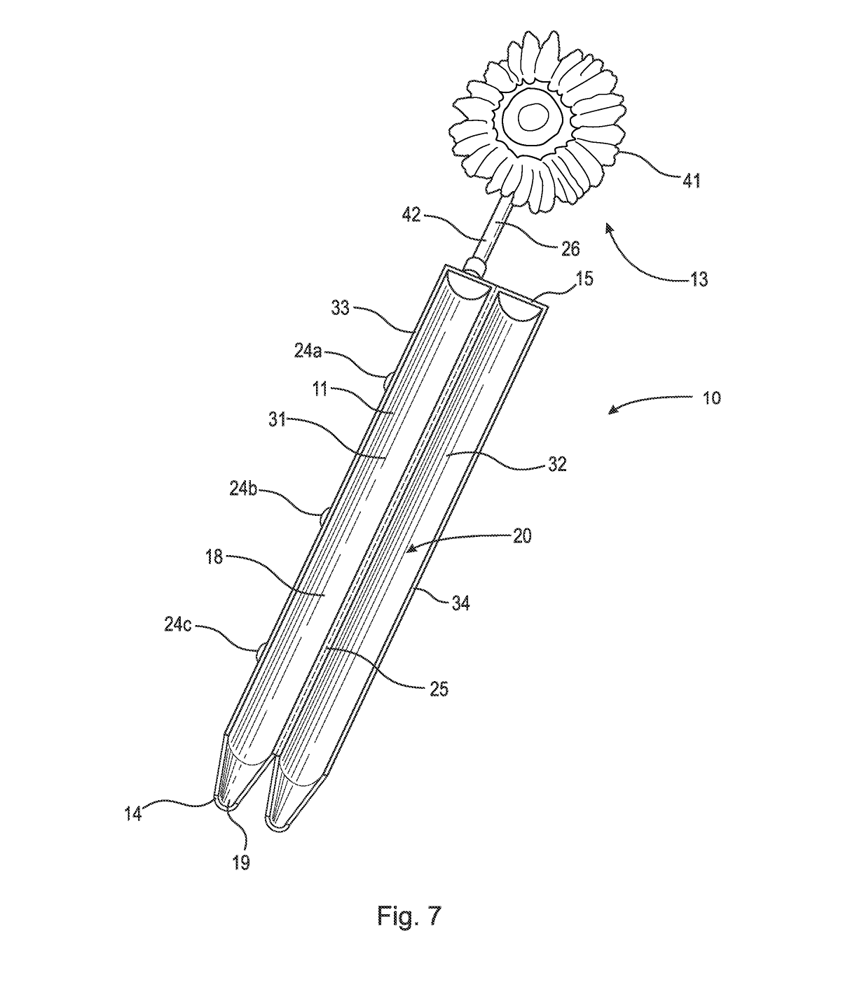

FIG. 7 is a front perspective view of cover 10, shown in an open position.

As shown in FIGS. 1 through 7, in a first embodiment, body 11 has first end 14, second end 15, inner surface 18, outer surface 16, and space 20 bounded by inner surface 18. As shown in FIG. 1, space 20 is operatively arranged to hold a writing instrument, such as pen 93, and pen 93 rests upon inner surface 18 of body 11 when a writing instrument is disposed within space 20. First end 14 of body 11 includes opening 19 through which pen tip 95 extends through in order to contact paper 92. Protrusion has first end 28 and second end 29, where first end 28 is secured to and extends upwardly from second end 15 of body 11. Decorative element 13, having extension member 26, is shown in the first embodiment as flower 41, having stem 42, extending downwardly from flower 41. In general, extension member 26 is secured to second end 29 of protrusion 12.

In the first embodiment, body 11 further includes at least one opening means, preferably hinge 25, extending longitudinally along body 11. Hinge 25 divides body 11 into first portion 31 and second portion 32 and first portion 31 and second portion 32 pivot outwardly and inwardly about hinge 25 to form open and closed positions, respectively. Body 11 further includes at least one fastening means, preferably latches 24a, 24b, and 24c, to secure body 11 in a closed position. Additionally, first portion 31 includes first portion edge 33 and second portion 32 includes second portion edge 34, such that when body 11 is secured in a closed position, first portion edge 33 and second portion edge 34 contact one another. Protrusion 12 further includes inner surface 23, outer surface 22, and cavity 21 bounded by inner surface 23, and at least a portion of stem 42 is disposed within cavity 21, such that when at least a portion of stem 42 is disposed within cavity 21, the portion of stem 42 contacts inner surface 23.

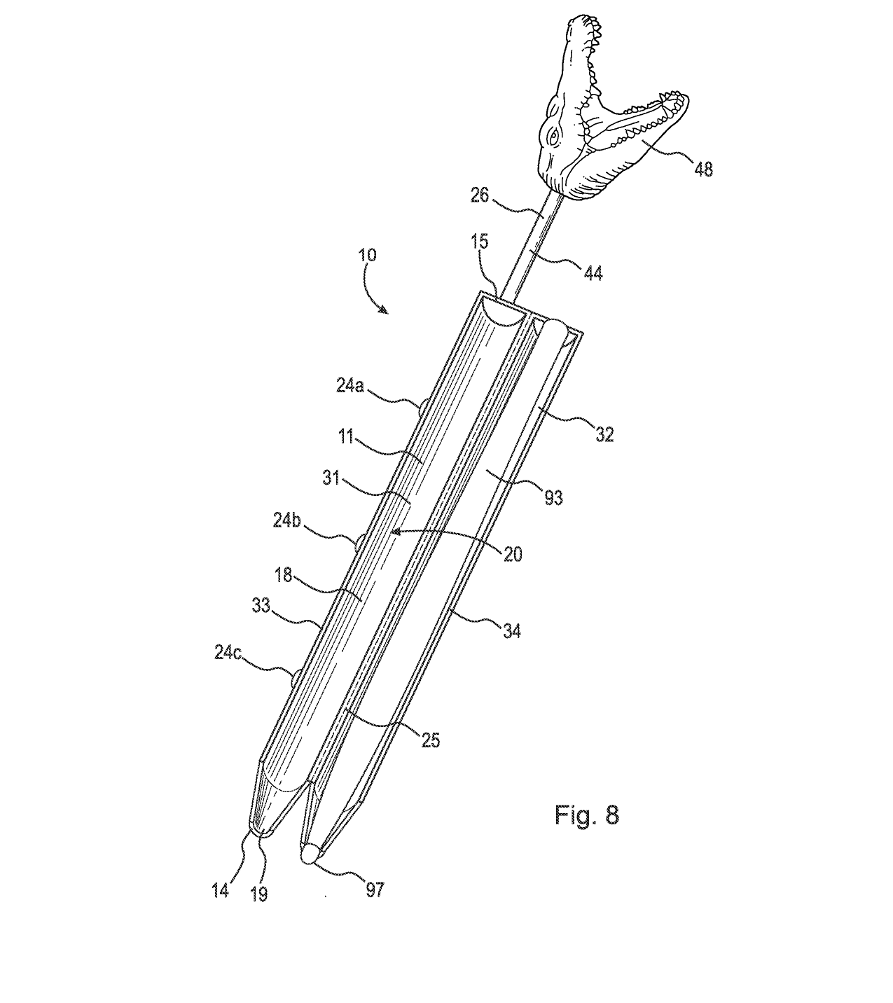

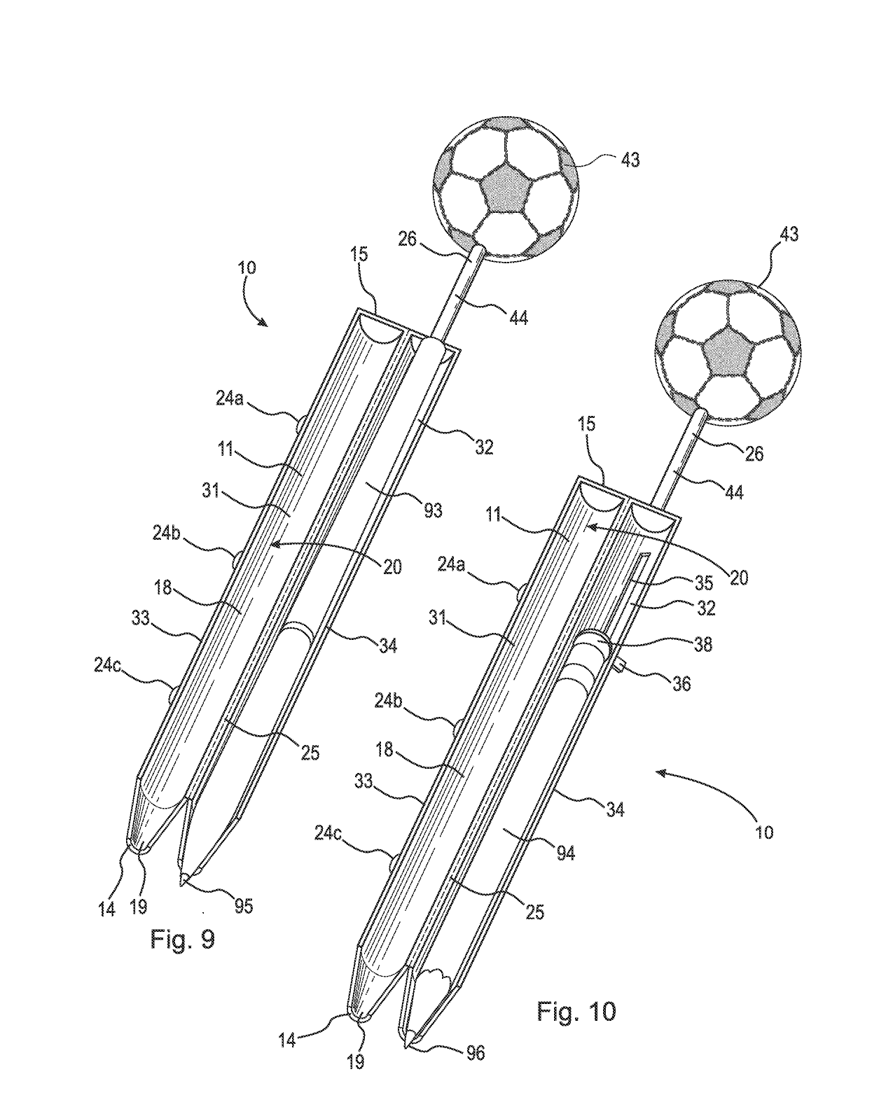

FIG. 8 is a front perspective view of a second embodiment of cover 10, shown in an open position, having stylus 97 disposed within space 20. Stylus tip 98 is arranged proximate to first end 14, which tapers downwardly similar to the taper of pen tip 95. As shown, the end of stylus 97 opposite stylus tip 98 contacts second end 15 of body 11. In this embodiment, it is necessary for stylus 98 to contact second end 15 of body 11, otherwise stylus 98 would be displaced within body 11. Unlike in the first embodiment, which included a floral decorative element, FIG. 9 includes alligator 48 and tubular extension 44 as decorative element 13 and extension member 26, respectively.

As shown in FIG. 9, pen 93 is disposed within space 20. Pen tip 95 is arranged proximate to first end 14, which tapers downwardly similar to the taper of pen tip 95. As shown, the end of pen 93 opposite pen tip 95 contacts second end 15 of body 11. In this embodiment, it is necessary for pen 93 to contact second end 15 of body 11, otherwise pen 93 would be displaced within body 11. Unlike in the first embodiment, which included a floral decorative element, FIG. 8 includes soccer ball 43 and tubular extension 44 as decorative element 13 and extension member 26, respectively.

FIG. 10 is a front perspective view of a fourth embodiment of cover 10, shown in an open position, having pencil 94 disposed within space 20.

As shown in FIG. 10, in the third embodiment, body 11 further includes slot 35, lever 36, and disc 38. Lever 36 is disposed within slot 35 and is operatively arrange to move longitudinally along slot 36 in order to accommodate writing instruments of varying heights. Thus, as shown, tip 96 of pencil 94 can be sharpened, causing the height of pencil 94 to decrease. As the height of pencil 94 decreases, lever 36 is depressed longitudinally along slot 35 to prevent the pencil from sliding upward within body 11 when tip 96 is pressed. Preferably, disc 38 is integral with lever 36 and contacts pencil 94 to prevent pencil 94 from being displaced within space 20 as the length of pencil 94 decreases. Similar to FIG. 9, FIG. 10 includes soccer ball 43 and tubular extension 44 as decorative element 13 and extension member 26, respectively.

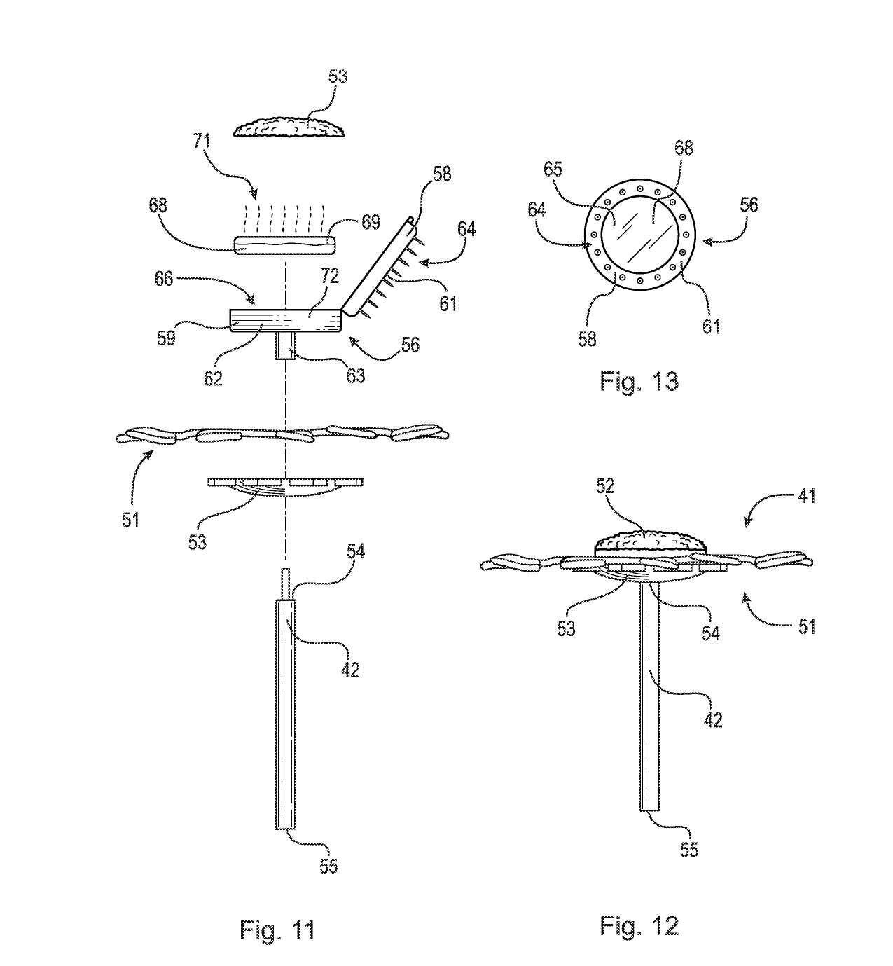

FIG. 11 is an exploded view of an embodiment of decorative element 13, in particular flower 41, shown having housing 56 in an open position and fragrance disc 68 disposed within cavity 66. Similarly, FIG. 12 is a front elevational view of flower 41, shown in an assembled and closed position. Moreover, FIG. 13 is a detailed top plan view of housing 56.

As shown in FIGS. 11 through 13, flower 41 broadly includes housing 56, fragrance disc 68, and means 63 for securing the decorative element to an accessory. Housing 56 has top 58, base 59, and attachment means 57. Attachment means 57 secures top 58 to base 59 and top 58 is pivotable about base 59. Base 59 has outer surface 72, inner surface (not shown), side 62 and cavity 66 bounded by side 62. Top 58 includes rim 61 and at least one aperture 65 bounded by rim 61. Fragrance disc 68 has an outer surface and an inner surface and is disposed within cavity 66 bounded by side 62 and fragrance disc 68 rests upon the inner surface of base 59. Fragrance disc 68 is filled with scented medium 69, which releases scent 71. Preferably, attachment means 57 is a hinge and means 63 for securing flower 41 to an accessory extending downwardly from housing 56. Stem 42 of flower 41 has first end 54 and second end 55. First end 54 is secured to means 63 and second end 55 is secured to an accessory, such as body 11 of cover 10.

Preferably, housing 56 is substantially circular in shape, in particular, top 58 is convex, and housing 56 is made of plastic. Preferably, decorative element 13 is substantially flower-shaped. However, it should be appreciated that any of the elements can be made of any suitable material known in the art and can be of any suitable shape known in the art.

Top 58 further includes at least one barb 64 extending upwardly therefrom, and flower 41 further includes flower ovary 52 and plurality of petals 51. Flower ovary 52 is secured to at least one barb 64 and plurality of petals 51 are disposed circumferentially about base 59. Preferably, scented medium 69 is a perfume or an essential oil. However, is should be appreciated that the scented medium can be made of any suitable medium known in the art. Essential oils, such as lavender, have been thought to promote health benefits, such as soothing nervous tension, headaches, anxiety and depression, inducing sleep, relieving pain from soreness in the joints, disinfecting the scalp and skin, enhancing blood circulation, treating respiratory problems, and increasing the mobility of the intestine, as well as a variety of other health benefits.

In the various embodiments, the decorative element is substantially flower-shaped, spherically shaped, and in particular, a sports ball, or in the shape of an alligator. However, it should be appreciated that the decorative element can be any suitable shape known in the art. Furthermore, preferably, the body is made of plastic and substantially tubular-shaped.

However, it should be appreciated that the body can be made of any suitable material known in the art and can be of any suitable shape known in the art. It should also be appreciated that, any of the fastening means of the cover can be any suitable fastening means known in the art, such as but not limited to, latches, snaps, hooks, etc.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A cover for a writing instrument, comprising:
a body, having a first end, a second end, an inner surface, an outer surface, and a space bounded by the inner surface, wherein the space is operatively arranged to hold a writing instrument;
a protrusion, having a first end and a second end, wherein the first end is secured to and extends upwardly from the second end of the body; and,
a decorative element, having an extension member extending downwardly therefrom, wherein the extension member is secured to the second end of the protrusion.

2. The cover of claim 1, wherein the protrusion further includes an inner surface, an outer surface, and a cavity bounded by the inner surface, and at least a portion of the extension member is disposed within the cavity.

3. The cover of claim 1, wherein the body further includes at least one opening means extending longitudinally along the body.

4. The cover of claim 3, wherein the opening means is a hinge.

5. The cover of claim 4, wherein the hinge divides the body into a first portion and a second portion and the first and second portions pivot outwardly about the hinge to form an open position.

6. The cover of claim 1, wherein the body further includes at least one fastening means to secure the body in a closed position.

7. The cover of claim 6, wherein the at least one fastening means includes at least one latch.

8. The cover of claim 1, wherein the decorative element is substantially flower-shaped.

9. The cover of claim 1, wherein the body further comprises a slot and a lever, wherein the lever is disposed within the slot and is operatively arrange to move longitudinally along the slot to accommodate writing instruments of varying heights.

10. A cover for a writing instrument, comprising:
a body, having a first end, a second end, an inner surface, an outer surface, and a space bounded by the inner surface, wherein the space is operatively arranged to hold a writing instrument;
a decorative element, having an extension member extending downwardly therefrom, wherein at least a portion of the extension member is secured to and extends upwardly from the second end of the body; and,
at least one opening means extending longitudinally along the body wherein the at least one opening means divides the body into a first portion and a second portion and the first and second portions pivot outwardly about the at least one opening means to form an open position.

11. The cover of claim 10, wherein the body further includes at least one fastening means to secure the body in a closed position.

12. The cover of claim 10, wherein the extension member is integral with the second end of the body.

13. A decorative element, comprising:
a housing, the housing having a top, a base, and an attachment means that secures the top to the base and the top is pivotable about the attachment means, the base having an outer surface, an inner surface, a side and a cavity bounded by the side, wherein the top includes a rim and at least one aperture bounded by the rim;
a fragrance disc, the fragrance disc having an outer surface and an inner surface, wherein the fragrance disc is disposed within the cavity bounded by the side and rests upon the inner surface of the base and the fragrance disc is filled with a scented medium; and,
a means for securing the decorative element to an accessory.

14. The decorative element of claim 13, wherein the attachment means is a hinge.

15. The decorative element of claim 13, wherein the housing is substantially circular in shape.

16. The decorative element of claim 13, wherein the decorative element is substantially flower-shaped.

17. The decorative element of claim 16, wherein the means for securing the decorative element to an accessory is an extension member extending downwardly therefrom.

18. The decorative element of claim 17, wherein the top further comprises at least one barb extending upwardly therefrom, and the decorative element further comprises a flower ovary and a plurality of petals, wherein the flower ovary is secured to the at least one barb and the plurality of petals are disposed circumferentially about the base.

19. The decorative element of claim 13, wherein the scented medium is an essential oil.

20. The decorative element of claim 13, wherein the top is substantially convex.
